(19) United States
(12) Patent Application Publication
(10) Pub. No.: US 2026/0013433 A1
(43) Pub. Date: Jan. 15, 2026

(54) COMBINE HARVESTER AND METHOD FOR OPERATING A COMBINE HARVESTER

(71) Applicant: CLAAS Selbstfahrende Erntemaschinen GmbH, Harsewinkel (DE)

(72) Inventors: Waldemar Thiesmann, Osnabrück (DE); Axel Jensen, Helsinge (DK); Bastian Bormann, Gütersloh (DE); Marvin Barther, Steinhagen (DE); Maik Heufekes, Münster (DE); Dirk Speckamp, Hamm (DE); Gabriel Gosden, Gentofte (DK); Hans Larsen, Hørsholm (DK); Lars Vestergaard, Vanløse (DK); Sven Carsten Belau, Gütersloh (DE)

(73) Assignee: CLAAS Selbstfahrende Erntemaschinen GmbH, Harsewinkel (DE)

(21) Appl. No.: 19/263,742

(22) Filed: Jul. 9, 2025

(30) Foreign Application Priority Data
Jul. 9, 2024 (DE) 10 2024 119 411.1

(51) Int. Cl. A01D 41/127

(52) U.S. Cl. CPC A01D 41/1271; A01D 41/1276

(57) ABSTRACT

A combine harvester and a method for operating a combine harvester. The combine harvester includes a threshing device and a separating device as working units which process harvested material collected for separating grain and transfer a flow of harvested material containing substantially the grain to a cleaning device, which is another working unit. The cleaning device supplies a flow of harvested material containing unthreshed harvested material to the threshing device for rethreshing using a transfer device and supplies a cleaned flow of harvested material to a grain tank using a conveyor device. The combine harvester includes a camera system to recording images of the flow of material to be transferred and an image evaluation device to evaluate the images. A driver assistance system controls the working units based on indicators, determined by the image evaluation device evaluating the images, of processing losses caused by the working units.

### CROSS REFERENCE TO RELATED APPLICATION

This application claims priority under 35 U.S.C. § 119 to German Patent Application No. DE 10 2024 119 411.1 filed Jul. 9, 2024, the entire disclosure of which is hereby incorporated by reference herein.

### TECHNICAL FIELD

The present invention relates to a combine harvester and a method for operating a combine harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

U.S. Pat. Nos. 7,670,218 and 7,713,115, both of which are incorporated by reference herein in their entirety, disclose a combine harvester that includes a threshing device and a separating device as working units, which process harvested material collected by the combine harvester to separate grain and transfer a flow of harvested material substantially containing the grain to a cleaning device. Using a transfer device, the cleaning device supplies a flow of transfer material containing unthreshed harvested material to the threshing device to be rethreshed. The flow of harvested material cleaned by the cleaning device is supplied to a grain tank using a grain elevator. A grain flow measuring device and a volume flow sensing device may be assigned to the transfer device. The grain flow measuring device may be formed by rod sensors (alternatively termed sensor rods or sensor bars, which may be arranged or spaced from each other along a width, such as the width of the cleaning) that use the structure-borne sound principle to register the contacts with grains (contained in the harvested material flow that is transferred within the combine harvester) as transferred grain content. The volumetric flow measuring device may detect the quantity of transferred harvested material transported by the transfer device. In addition to the loss quantities of the separating device and the cleaning device detected by knock sensors, an evaluation and display unit may use the transferred grain share and the transferred harvested material quantity to control one or more operating parameters of components of the cleaning device, top sieve, bottom sieve, and cleaning fan.

U.S. Pat. No. 10,231,380, incorporated by reference herein in its entirety, discloses a combine harvester that includes a driver assistance system configured to control the threshing device. For this purpose, threshing losses may be determined by a sensor array using a threshing loss sensor, a broken grain fraction using a broken grain sensor, separation losses using a separation loss sensor, cleaning losses using a cleaning loss sensor, which may comprise harvesting process parameters. In turn, the driver assistance system may control the threshing device by controlling one or more of the harvesting process parameters.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates an exemplary schematic side view of a self-propelled combine harvester.

FIG. 2 illustrates an exemplary schematic partial view of the combine harvester with a transfer device.

FIG. 3 illustrates an exemplary schematic perspective view of an embodiment of a camera of a camera system for detecting the composition of a flow of transferred material transported by the transfer device.

FIG. 4 illustrates an exemplary schematic image of the flow of transferred material analyzed and classified by means of an image evaluation device.

FIG. 5 illustrates a schematic representation of the combine harvester's automatic setting units.

### DETAILED DESCRIPTION

As discussed in the background, the control of the cleaning device or the threshing device is based on harvested material losses, generated by working units, in the form of harvested material discharged from the combine harvester. However, this evaluation of harvested material losses may be imprecise since the threshing quality, determined to evaluate the harvested material losses, may not be accurate.

In this regard, a combine harvester and a method for operating a combine harvester, which improves detection of the threshing quality, are disclosed.

In one or some embodiments, a combine harvester is disclosed that includes a threshing device and a separating device as working units, which are configured to process harvested material picked up or collected by the combine harvester, with the working units configured to separate grain and transfer a flow of harvested material containing mostly the grain to a cleaning device, which may comprise another working unit. The cleaning device may be configured to supply the transferred harvested material flow (which may contain unthreshed harvested material) to the threshing device for rethreshing using a transfer device, and may feed a cleaned flow of harvested material to a grain tank using a conveyor device. In one or some embodiments, the combine harvester comprises a camera system configured to automatically record or generate one or more images of the transferred harvested material flow, an image evaluation device configured to evaluate the images, and a driver assistance system configured to control one or more of the working units. The image evaluation device may be configured to: automatically analyze the one or more images of the transferred harvested material flow in order to determine one or more indicators of processing losses caused by at least one of the working units; and automatically transmit one or more indicators to the driver assistance system. In turn, the driver assistance system may, based on the one or more indicators, automatically control at least one of the working units.

In one or some embodiments, processing losses of the working units may significantly be influenced by the threshing process that is performed by the threshing device. The processing loss of the threshing device may result from unthreshed harvested material, which may be supplied to the separating device and the cleaning device. If the unthreshed harvested material passes through these working units, the unthreshed harvested material is either discharged from the combine harvester or it is proportionally fed to the transfer device or the grain tank as a transferred harvested material flow.

To qualify and quantify the processing losses, the image(s) of the harvested material flow may be automatically recorded by the camera system and automatically transmitted to the image evaluation device for evaluation. The image evaluation device may automatically analyze the image(s) of the flow of harvested material flow to determine the one or more indicators of the processing losses and automatically transmit the one or more indicators to the driver assistance system, which may analyze the determined one or more indicators into account when automatically controlling at least one of the working units.

This may enable a more in-depth analysis of the content of the flow of returned material and therefore the influence and/or the interactions of adjusting the working units to the nature and composition of the flow of returned material.

Using the camera system may enable monitoring, such as continuous monitoring, of the flow of harvested material. In one or some embodiments, the flow of harvested material may be in various parts of the combine harvester. Merely as one example, the flow of material that is transferred for rethreshing comprises a flow of transferred harvested material. Thus, the image evaluation device may automatically analyze a large number of images of the flow of harvested material (continuously automatically recorded and by the camera system, which may allow for a high number of samples). Further, the image evaluation device may analyze the flow of harvested material in one or more parts of the combine harvester.

In particular, various indicators of processing losses are contemplated. For example, the indicators may be a threshing quality and/or a detected portion of unthreshed fractions of the harvested material in the flow of transferred material. In one or some embodiments, the image evaluation device may be configured to automatically display the results of the analysis to the operator of the combine harvester via an operating and display unit (e.g., a touchscreen).

Unthreshed fractions may include whole ears, filled ear tips, aristate grains, husked grains, panicles and/or spindle segments covered with grains.

In one or some embodiments, the threshing quality may be determined by any one, any combination, or all of: a portion (e.g., a percentage) of broken grains; cracks in the grain; a portion of unthreshed fractions; a portion of non-grain components; or a portion of foreign material in the flow of transferred material.

In one or some embodiments, the image evaluation device may consider a large number of individual factors in determining the indicators of threshing quality and/or the portion of unthreshed fractions, which determine the threshing quality and the portion of unthreshed fractions. For example, the processing losses may include a loss portion of unthreshed fractions of the harvested material separated from the combine harvester by the separating device and the cleaning device, which may have remained unprocessed due to the threshing quality achieved by the settings of the threshing device.

In one or some embodiments, the camera system may comprise at least one camera which is integrated (e.g., bolted to, joined to, etc.) into at least one component of the transfer device along the conveying path of the transfer device.

The transfer device may comprise one or more components, such as a guide surface below the cleaning device, a cross-feeding screw conveyor arranged in a trough, and a conveyor device, wherein the flow of transferred material separated by the cleaning device may pass via the guide surface into the cross-feeding screw conveyor, which may feed the flow of transferred material to the threshing device via the conveyor device.

In particular, the at least one camera may be integrated into any one, any combination, or all of into the guide surface, into the trough, along the conveying path of the conveyor device, in the delivery area of the conveyor device above the threshing device, or in the transfer area between the cross-feeding screw conveyor and the conveyor device. For example, a first camera may be integrated in the guide surface, in the trough, along the conveying path of the conveyor device, in the delivery area of the conveyor device above the threshing device, and a second camera may be integrated in the transfer area between the cross-feeding screw conveyor and the conveyor device. Integration of the at least one camera in the guide surface and/or in the trough may offer the advantage that the contents of the flow of transferred material may be detected over a greater width. The integration of the at least one camera along the conveying path of the conveyor device may be particularly advantageous in terms of installation space.

In particular, a transparent viewing window may be incorporated in the guide surface and/or in the trough. Sapphire glass or another wear-resistant material may be used as the material for the viewing window. The overflow of the viewing window by the flow of transferred material may have the advantage that the viewing window may be continuously cleaned.

In one or some embodiments, the image evaluation device may be configured to analyze the images of the flow of transferred material recorded by the camera system using a machine learning algorithm. The machine learning algorithm may make it possible to analyze the images of the flow of transferred material automatically and cost-effectively during harvesting mode. In particular, the analysis may be performed or executed in real time.

For this purpose, the machine learning algorithm may comprise at least one trainable neural network configured to analyze the image(s), wherein the at least one neural network may analyze the image(s) received from the camera system pixel-by-pixel using semantic segmentation and may subject the pixels to classification.

In one or some embodiments, the image analysis may be performed by the at least one neural network using instance segmentation. Instance segmentation may combine the advantages of semantic segmentation and object detection. With the help of instance segmentation, objects may be assigned to different classes with pixel precision. This technology may be particularly helpful in applications where objects are very close to each other, touch each other or overlap, which may be the case in the image analysis of the transfer flow. Instance segmentation may make it possible to determine the position of the objects to be classified in the image and their shape.

In particular, the classification by the machine learning algorithm may be based on a plurality of classes, such as from any one, any combination, or all of: whole ears; filled ear tips; aristate grains; husked grains; panicles; spindle segments covered with grains; weed seeds; husks; stalks; pods; spindles; straw; or foreign bodies from any one, any combination, or all of whole ears; filled ear tips; aristate grains; husked grains; panicles; spindle segments covered with grains; weed seeds; husks; stalks; pods; spindles; straw; or foreign bodies. In addition to the division into different classes, the number of objects detected in each class may also be determined. The large number of different classes may enable a more precise analysis of the composition of the flow of transferred material so that the assessment of the threshing quality may also be improved as a result.

In one or some embodiments, the driver assistance system may be configured to automatically generate one or more control signals for controlling at least one of the working units depending on the classification in order to reduce or minimize processing losses.

In one or some embodiments, the driver assistance system with the threshing device and the cleaning device may each respectively form an independently operating automatic setting unit, which may serve to improve or optimize the control of the threshing device and/or the cleaning device for performing a given partial work process.

In one or some embodiments, the image evaluation device may be configured to generate the one or more indicators of the processing losses (previously determined by the image evaluation device using the image analysis) available to one or more of the automatic setting units as input variables.

The task posed at the beginning may further be solved by a method for performing the actions or functions described herein. In one or some embodiments, the method for operating a combine harvester is disclosed in which the combine harvester has a threshing device and a separating device as working units, which may process harvested material collected by the combine harvester for separating grain and transfer a flow of harvested material containing mostly the grain to a cleaning device, which is another working unit. From the cleaning device, a flow of transferred material containing unthreshed harvested material is fed to the threshing device for rethreshing using a transfer device, and a cleaned flow of harvested material is fed to a grain tank. In one or some embodiments, image(s) of the transferred harvested material flow are automatically recorded by a camera system arranged in the combine harvester and automatically transmitted to an image evaluation device for evaluating the image(s). A driver assistance system may control one or more of the working units. Specifically, the image evaluation device may automatically analyze the recorded images of the transferred harvested material flow to determine one or more indicators of processing losses caused by at least one of the working units and may automatically transmitted to the driver assistance system. In turn, the driver assistance system may take the one or more indicators into account when automatically controlling at least one of the working units. Reference may be made to the explanations of the self-propelled combine harvester according to one or more aspects of the invention.

In one or some embodiments, a selection of images analyzed by the image evaluation device may be displayed to the operator using the operating and display unit. In the images to be displayed, the various classes, which may be determined by the classification using the machine learning algorithm, may be shown visually distinguished (e.g., via one or more overlaps or modifications of the underlying images).

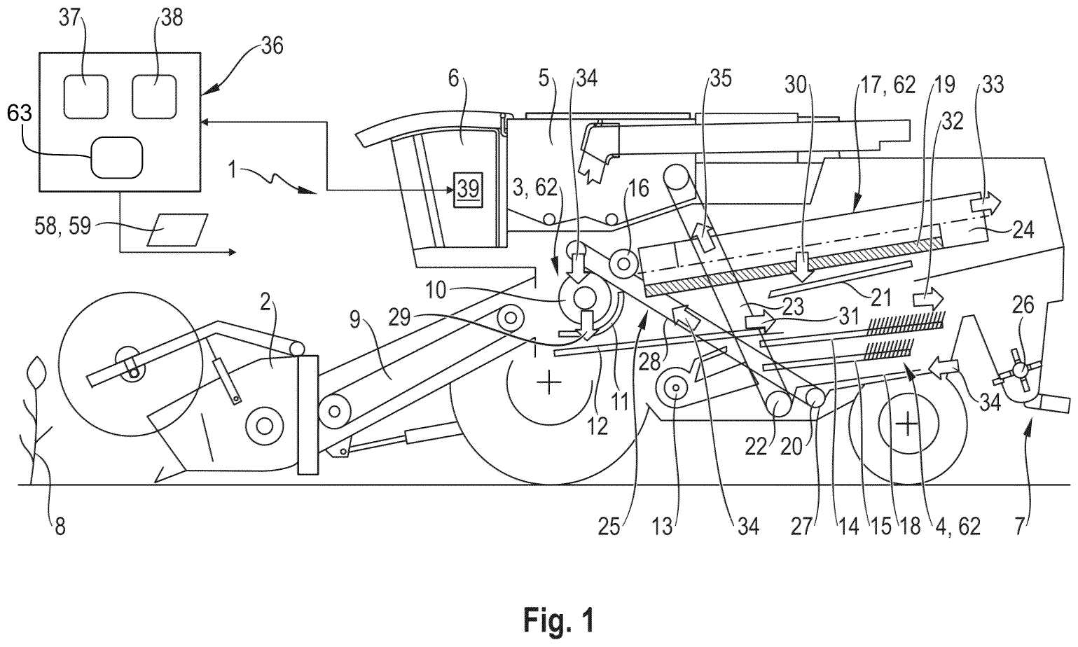

Referring to the figures, the illustration in FIG. 1 illustrates an example schematic side view of a self-propelled combine harvester 1. Combine harvesters are disclosed in US Patent Application Publication No. 2023/0397533 A1, US Patent Application Publication No. 2024/0081182 A1, US Patent Application Publication No. 2024/0196796 A1, US Patent Application Publication No. 2025/0048965 A1, each of which are incorporated by reference herein in their entirety.

In its front area, the combine harvester 1 may bear or have connected thereto a front attachment 2, such as a height-adjustable cutting unit which may harvest grown harvested material 8 across a large width, bring it together in a lateral direction, and transfer it to an inclined conveyor element 9. Via the inclined conveyor unit 9, the harvested material 8 may reach a threshing device 3 in a manner known per se, which, according to the depicted embodiment, comprises at least one threshing drum 10, a feed drum 16 arranged downstream thereof, and at least one threshing concave 11. In addition, the threshing device 3 may comprise a pre-accelerator drum which may be positioned upstream of the threshing drum 10. The pre-accelerator drum may also have a threshing concave. Detailed below are examples of various flows of the harvested material. Further, detailed below are examples of obtaining images of the one or more flows of the harvested material, analysis of the images of the one or more flows of the harvested material, and control of the combine based on the analysis. In this regard, any one, any combination, or all of the flow discussed herein may be recorded, analyzed, and used to control the combine harvester.

For example, a harvested material flow 29 may comprise (or consisting substantially of) a mixture of grains, short straw and chaff is separated from the harvested material 8 through openings in the threshing concave 11 and may fall onto a grain pan 12 arranged below the threshing concave 11. Using vibration movements of the oscillatingly driven grain pan 12, the harvested material 8 contained in the harvested material flow 29 may be conveyed to the rear in the direction of a cleaning device 4.

The part of the harvested material flow 29 that has not passed through the threshing concave 11 may be conveyed further by the feed drum 16 to a separating device 17, which may be designed as an axial separation rotor and which may extend in the longitudinal direction of the combine harvester 1. The axial separation rotor may be surrounded in its lower area by a semi-cylindrical separator concave 19 through which a harvested material flow 30 comprising (or consisting substantially of) a mixture of grains and ear fragments is separated, which may reach a returns pan 21 arranged below the separator concave 19 of the axial separation rotor.

Instead of a single axial separation rotor, two axial separation rotors may also be used in parallel next to each other. Alternatively, a tray shaker may be used as the separating device 17 instead of the at least one axial separation rotor.

Residual harvested material, such as substantially straw which is ejected at the rear end 24 of the separating device 17 as a residual harvested material flow 33, may reach a distribution device 7 at the rear of the combine harvester 1 where it may be comminuted by a chaff cutter 26 and finally spread on the ground of a field.

On the oscillatingly driven returns pan 21, the harvested material flow 30 discharged through the separator concave 19 of the separating device 17 may be conveyed in the direction of the threshing device 3 and may be transferred to the grain pan 12, where the harvested material flow 30 of the returns pan 21 may combine with the harvested material flow 29, which has passed through at least the threshing concave 11 and may be discharged from the grain pan 12 to the cleaning device 4.

The cleaning device 4 may comprise a top sieve 14, a bottom sieve 15 and a cleaning fan 13, which may generate an air flow passing through and over the sieves 14, 15. The grain contained in the harvested material flows 29, 30 fed to the grain pan 12 or the returns pan 21 may pass through the top sieve 14 and the bottom sieve 15 in succession as a combined harvested material flow 31 and may reach a screw conveyor 22 and a grain elevator 23 as a cleaned harvested material flow 35 via an underlying floor 18, which may convey it into a grain tank 5 arranged at the rear of the driver's cab 6.

Components of the combined harvested material flow 31 that are lighter than the grain may be caught and entrained by the air flow of the cleaning fan 13 while falling from the grain pan 12 onto the top sieve 14, from the top sieve 14 onto the bottom sieve 15 or from the bottom sieve 15 onto the floor 18, reach the distribution device 7 and may be discharged via this as a partial flow 32. Heavier, coarser parts of the harvested material flow 31, such as unthreshed ear tips, grains partially enclosed by husks or awns, may reach a guide surface 40 arranged below the bottom sieve 15 as a flow of transferred harvested material 34 at the rear end of the sieves 14, 15. From the guide surface 40, the flow of transferred harvested material 34 may pass into a trough 27 extending transversely below the sieves 14, 15. A cross-feeding screw conveyor 20 rotating in the trough 27 may convey the flow of transferred material 34 sideways to a conveyor device 28, which may comprise a transfer elevator. The conveyor device 28, as part of a transfer device 25, may convey the flow of transferred harvested material 34 back to the threshing device 3 to be rethreshed. A rethreshing device may be arranged on or in the conveyor device 28.

The threshing device 3, the separating device 17, and the cleaning device 4 may form working units 62 of the combine harvester 1. The combine harvester 1 may further comprise a driver assistance system 36 configured to automatically control these working units 62.

In particular, the driver assistance system 36 may automatically control the combine harvester 1 by automatically setting one or more machine parameters on the working units 62 as a control and/or regulation system. In one or some embodiments, the driver assistance system 36 may be directly integrated into the functions of the combine harvester 1.

In one or some embodiments, driver assistance system 36 may comprise at least one memory 37 configured to store data (e.g., the one or more indicators) and/or computer-executable instructions stored on the tangible memory, and at least one computing device 38 configured to process the data stored in memory 37 and configured to execute the computer-executable instructions. Moreover, at least one communication interface 63 may be configured to communicate with devices external to the driver assistance system 36, such as the one or more working units 62, or the like.

Thus, the computing device 38 and the memory 37 may be in communication (e.g., wired and/or wirelessly) with one another. In one or some embodiments, the computing device 38 may comprise a microprocessor, controller, PLA, or the like. Similarly, the memory 37 may comprise any type of storage device (e.g., any type of memory, such as RAM, ROM, or a combination thereof). Though the computing device 38 and the memory 37 are depicted as separate elements, they may be part of a single machine, which includes a microprocessor (or other type of controller) and a memory. Alternatively, the computing device 38 may rely on the memory 37 for all of its memory needs. The memory 37 may comprise a tangible computer-readable medium that include software that, when executed by the computing device 38 is configured to perform any one, any combination, or all of the functionality described herein.

The computing device 38 and the memory 37 are merely one example of a computational configuration for the electronic devices discussed herein. Other types of computational configurations are contemplated. For example, all or parts of the implementations may be circuitry that includes a type of processor, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The data saved in the memory 37 may comprise information generated by internal machine sensor systems, information generated by external systems, and information saved directly in the computing device 38. The driver assistance system 36 may be operated via a control and display unit 39 (e.g., a touchscreen) arranged in the driver's cab 6 of the combine harvester 1. In principle, the driver assistance system 36 is configured to assist a driver of the combine harvester 1 operate the combine harvester 1.

The composition of the flow of transferred harvested material 34 may depend on the settings of the working units 62. In particular, the threshing device 3 and/or the cleaning device 4 may influence the composition of the flow of transferred harvested material 34.

In principle, the setting of the threshing device 3 may be selected so that threshing is as gentle as possible and as intensive as necessary. Since the tearing-off forces of the different grains are different in size, a compromise may be selected, and a certain amount of unthreshed harvested material 8 may therefore permissible (and effectively a necessary result). In an optimally adjusted combine harvester 1, the threshing concave 11 of the threshing device 3 or the separator concave 19 of the separating device 17 separates the unthreshed fractions 57B of the harvested material 8, and they are also separated by the top sieve 14 of the cleaning device 4. The separated, unthreshed fractions 57B enter the transfer device 25 as a flow of transferred harvested material 34 and are fed back to the threshing device 3. In this case, the setting(s) may be optimally selected.

If the unthreshed fractions 57B are not separated by the threshing device 3 or the separating device 17, they are fed to the chaff cutter 26 with the residual harvested material flow 31 and ejected by the distributing device 7 or deposited in the swath. There, the unthreshed fractions 57B separated with the residual harvested material flow 31 remain on the field as threshing losses.

The unthreshed fractions 57B separated by the threshing device 3 and the separating device 17, which do not pass through the top sieve 14, are distributed on the field with the partial flow 32 as threshing losses by a chaff spreader.

If the unthreshed fractions 57B pass through both the top sieve 14 and the bottom sieve 15, they may enter the grain tank 5 together with the cleaned harvested material flow 34 XXX. These unwanted additives may influence or affect the qualitative assessment of the grain during sale.

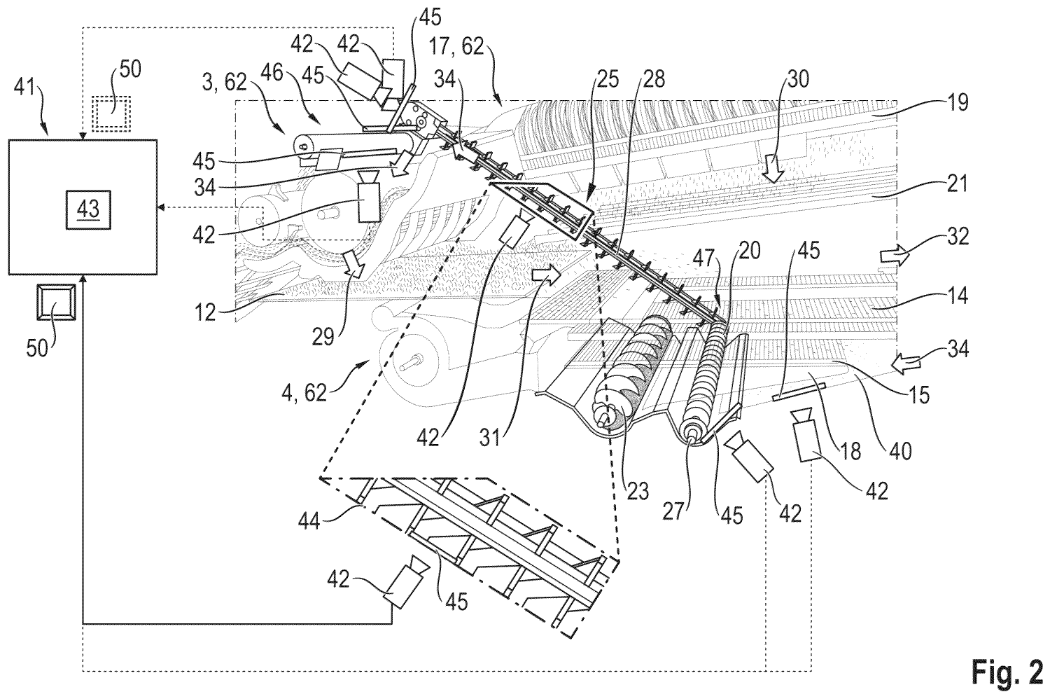

The illustration in FIG. 2 shows a schematic exemplary partial view of the combine harvester 1 with a transfer device 25. The transfer device 2 may comprise as components any one, any combination, or all of the guide surface 40 below the cleaning device 4, the cross-feeding screw conveyor 20 arranged in the trough 27, and the conveyor device 28. The flow of transferred material separated by the cleaning device 4 may pass via the guide surface 40 into the cross-feeding screw conveyor 20, which may feed the flow of transferred harvested material 34 using the conveyor device 28 to the threshing device 3 to be rethreshed.

As discussed above, the combine harvester 1 may comprise a camera system for automatically recording or generating images 50 of the flow of transferred harvested material 34 and an image evaluation device 41 configured to automatically evaluate the images 50 recorded by the at least one camera 42 of the camera system. The image evaluation device 41 is configured to automatically analyze the recorded images 50 of the flow of transferred harvested material 34 using a machine learning algorithm 43. The machine learning algorithm 43 may comprise at least one trainable neural network for analyzing the images 50, wherein the at least one neural network may analyze the images 50 received from the at least one camera 42 of the camera system pixel-by-pixel using semantic segmentation and may subject the pixels to a classification.

The camera system may comprise at least one camera 42 (e.g. a single camera or a plurality of cameras), which may be integrated into at least one component of the transfer device 25 along the conveying path of the transfer device 25. In this context, integrated into a component of the transfer device 25 may mean that the at least one camera 42 is assigned to or arranged in the at least one component of the transfer device 25 in such a way that the camera 42 is aligned by its detection range to the flow of transferred harvested material 34.

In one or some embodiments, the at least one camera 42 is arranged along the conveying path of the conveyor device 28. In one or some embodiments, the conveyor device 28 comprises a transfer elevator. A viewing window 45 transparent to visible light may be inserted into a wall segment 44 of the conveyor device 28 conveying the flow of transferred harvested material 34. The viewing window 45 may be provided with a coating layer on one or both sides in order to avoid unwanted reflections. Sapphire glass or another wear-resistant material may be used as the material for the viewing window 45. The flow of transferred material flowing over the viewing window 45 may have the advantage that the viewing window 45 is continuously cleaned.

Alternatively or additionally, the at least one camera 42 may be integrated into the guide surface 40. For this purpose, the viewing window 45 may be inserted into the guide surface 40. The camera 42 may thus accordingly be arranged below the guide surface 40.

Alternatively or additionally, the at least one camera 42 may be integrated into the trough 27 partially surrounding the cross-feeding screw conveyor 20. For this purpose, the viewing window 45 may be inserted into the wall of the trough 27.

Alternatively or additionally, the at least one camera 42 may be integrated in the delivery area 46 of the conveyor device 28 above the threshing device 3 and/or in the transfer area 47 between the cross-feeding screw conveyor 20 and the conveyor device 28.

In the case of an arrangement of the at least one camera 42 in the delivery area 46 of the conveyor device 28, the at least one camera 42 may be arranged axially parallel to the conveying path of the conveyor device 28. Alternatively or additionally, the at least one camera 42 may be arranged substantially perpendicular to the longitudinal axis of the combine harvester 1.

The image evaluation device 41 may be configured to automatically analyze the images 50 of the flow of transferred harvested material 34 to determine one or more indicators of processing losses caused by at least one of the working units 62 and to automatically transmit the one or more indicators to the driver assistance system 36. In turn, the driver assistance system 36 may automatically consider or analyze the one or more indicators when automatically controlling at least one of the working units 62 (e.g., the driver assistance system 36 may automatically select one or more modified or updated parameters of the one or more working units 62 in order to reduce the processing losses, effectively changing the one or more indicators).

Various indicators are contemplated. For example, the indicators may comprise a threshing quality 57A and/or a detected portion of unthreshed fractions 57B of the harvested material 8 in the flow of transferred harvested material 34.

The threshing quality 57A may be determined by any one, any combination, or all of: a portion of broken grains; cracks in the grain; a portion of unthreshed fractions 57B; a portion of non-grain constituents; or a portion of foreign matter in the flow of transferred harvested material 34. The portion of broken grains and cracks in the grain may be influenced or affected by the intensity of the threshing. With increasing intensity, the portion of broken grains may increase. If the intensity of threshing is too low, this may result in an increase in the portion of unthreshed fractions 57B in the harvested material flows 29, 30. In this regard, responsive to analyzing the threshing quality 57A, the driver assistance system 36 may automatically modify the intensity of the threshing (by modifying the setting(s)) of the threshing device 3.

Unthreshed fractions 57B may include any one, any combination, or all of: whole ears; filled ear tips; aristate grains; husked grains; panicles; or spindle segments covered with grains. The composition of the unthreshed fractions 57B may vary depending on the picked-up harvested material 8.

The processing losses may include a loss portion of unthreshed fractions 57B of the harvested material 8 separated from the combine harvester 1 by the separating device 17 and the cleaning device 4, which may have remained unprocessed due to the threshing quality 57A achieved by the settings of the threshing device 3. Again, in this regard, responsive to analyzing the unthreshed fractions 57B, the driver assistance system 36 may automatically modify the setting(s) of the threshing of the threshing device 3.

The classification by the machine learning algorithm 43 may be based on one or more classes, such as any one, any combination, or all of: whole ears; filled ear tips; aristate grains; covered grains; panicles; spindle segments covered with grains; weed seeds; husks; stalks; pods; spindles; straw; or foreign bodies.

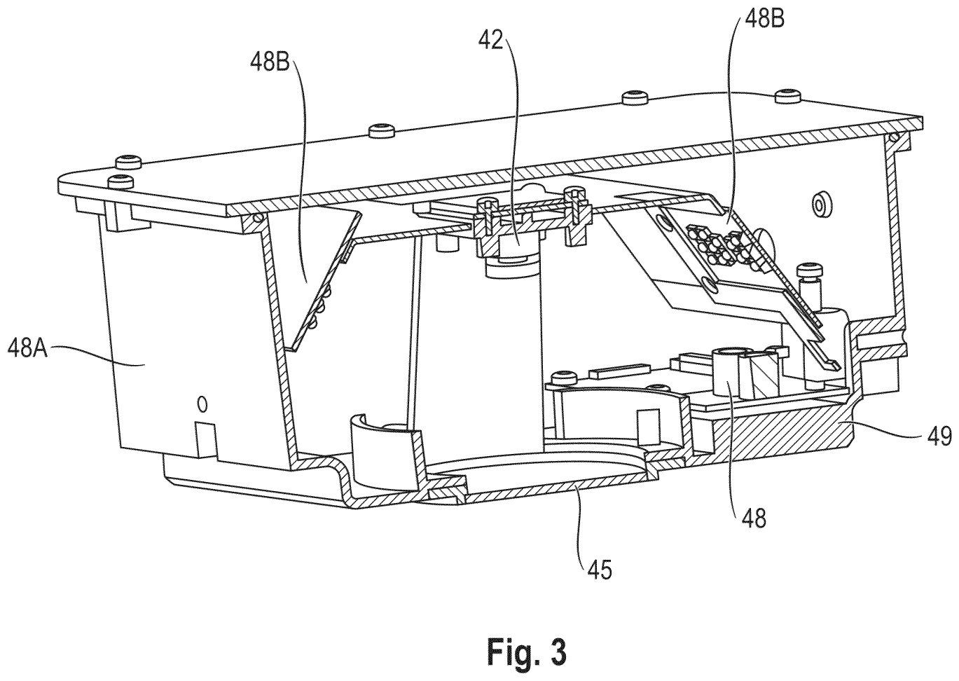

The illustration in FIG. 3 shows a schematic exemplary perspective view of an embodiment of the camera 42 of the camera system for detecting the composition of the flow of transferred harvested material 34 transported by the transfer device 25. The camera 42 may be arranged in a housing 48A. The camera 42 may include image sensor(s) and lens(es). The camera 42 may be arranged in front of the viewing window 45 and coaxial therewith. The viewing window 45 may be detachably attached to the housing 48A. LED arrays 48B may be arranged in the interior of the housing 48A for illumination. The LED arrays 48B may be arranged as close as possible to the viewing window 45 and at the same time in a position in which direct reflections in the image 50 recorded by the camera 42 from the viewing window 45 may be avoided. Furthermore, a computing unit 48 may be integrated into the housing 48A, which may be configured to execute the machine learning algorithm 43. In this case, the computing unit 48 integrated in the camera 42 may form the image evaluation device 41. In one or some embodiments, the computing unit 48 may include a memory 37 and a computer device 38. In this regard, any discussion regarding the memory 37 and the computer device 38 for the driver assistance system 36 may be applied to the computing device 38.

In one or some embodiments, the images 50 in the camera 42 are processed by the integrated computing unit 48. Since running the machine learning algorithm 43 is computationally intensive, the heat dissipation of the computing unit 48 may be high. In order to remove the waste heat from the computing unit 48, in one or some embodiments, the computing unit 48 is arranged next to or as close as possible to the flow of transferred harvested material 34. For this purpose, the computing unit 48 may be separated from the flow of transferred harvested material 34 by a heat-conducting component 49. The computing unit 48 may therefore be cooled by the passing flow of transferred harvested material 34. The camera 42 may have a communication interface (such as communication interface 63) in order to automatically transmit the data (e.g., the one or more indicators) generated by the computing unit 48, in evaluating the images, to the driver assistance system 36.

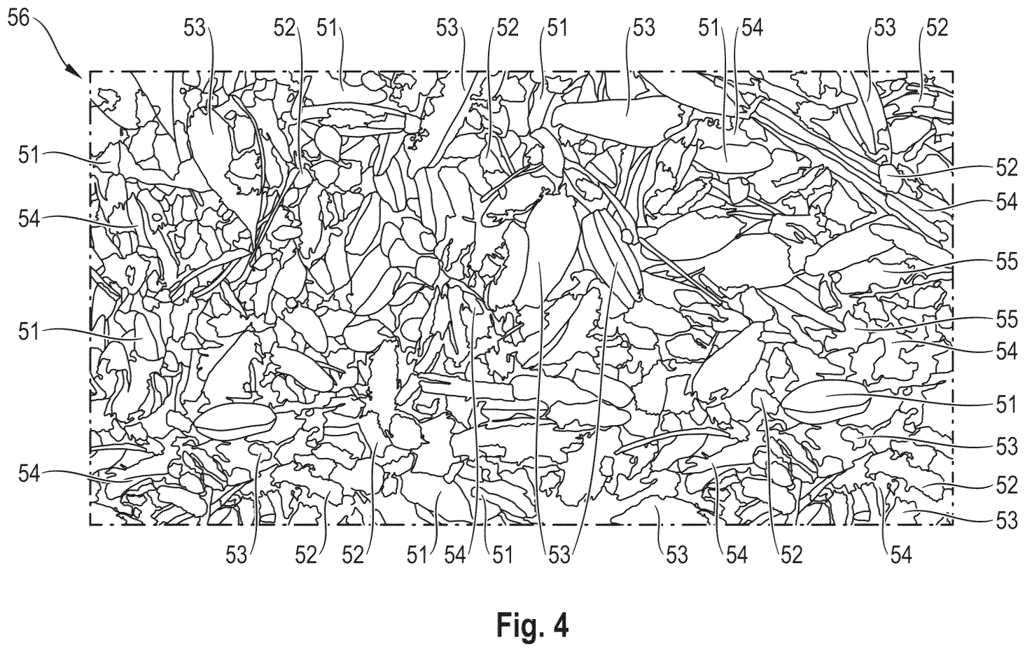

FIG. 4 shows schematically and by way of example a single image 56 of the flow of transferred harvested material 34 analyzed and classified using the image evaluation device 41. In FIG. 4, after image processing by running the machine learning algorithm 43, pixels of the image 50 of the flow of transferred harvested material 34 recorded by the at least one camera 42 may be classified as whole grains 51, as broken grains 52, as husks 53, as non-grain components 54 and as background 55. The classification of pixels as background 55 may refer to the areas of the image 50 recorded by the at least one camera 42 which are not a component of the flow of transferred harvested material 34, but are, for example, part of the transfer device 25 or another component of the combine harvester 1 which is located in the image capture area of the at least one camera 42.

For reasons of clarity, FIG. 4 does not show the more detailed classification into the classes from the group consisting of whole ears, filled ear tips, aristate grains, covered grains, panicles, spindle segments covered with grains, weed seeds, husks, stalks, pods, spindles, straw and/or foreign bodies.

Responsive to receiving the one or more indicators, the driver assistance system 36 may analyze the one or more indicators (e.g. the classification(s)) and, responsive to the analysis, generate control signals 58, 59 for controlling at least one of the working units 62 (e.g., modify operation of at least one of the working units 62) the depending on the classification in order to reduce or minimize processing losses. The in-depth classification may make it possible to assess the threshing quality 57A and/or the portion of unthreshed fractions 57B in greater detail. The control signals 58, 59 for adjusting or modifying the machine parameters of the working units 62 may therefore be better adapted to a processing strategy selected by an operator.

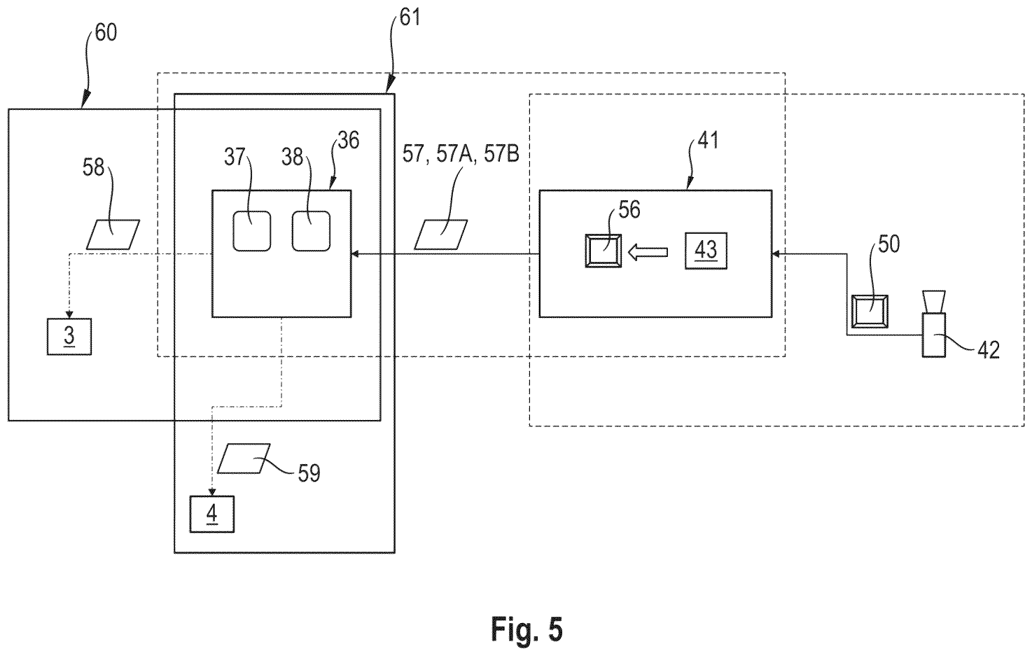

The illustration in FIG. 5 shows a schematic representation of automatic setting units 60, 61 of the combine harvester 1. The driver assistance system 36 together with the threshing device 3 and the cleaning device 4 may each form an independently operating automatic setting unit 60, 61, which may serve to optimize the execution of a given partial work process. The automatic setting unit 60 may serve to optimize the control of the threshing device 3, and the automatic setting unit 61 may serve to optimize the control of the cleaning device 4. For this purpose, a plurality of selectable harvesting process strategies may be saved in the memory 37 of the driver assistance system 36. The computing device 38 may be configured to autonomously determine and specify at least one machine parameter for the working unit 62 to be automatically controlled in order to implement the selected harvesting process strategy or harvesting process strategies. In this way, an automatic setting unit 60, 61 may be provided which automatically controls one, some or all of the variables relevant for the work of the given working unit 62 coordinated amongst each other.

In one or some embodiments, the image evaluation device 41 and the at least one camera 42 may form a unit. Alternatively, the image evaluation device 41 and the driver assistance system 36 may form a unit (e.g., have a common computer device 38 and a common memory 37, with the functionality of the image evaluation device 41 and the driver assistance system 36 having respective computer threads executed therein). The image evaluation device 41, the driver assistance system 36, and the at least one camera 42 may also be designed as spatially separate units, which may be arranged at different positions in the combine harvester 1.

In one or some embodiments, the image evaluation device 41 is automatically configured to provide the indicators determined by the image evaluation device 41 (e.g., the threshing quality 57A and/or the detected portion of unthreshed fractions 57B for the processing losses) to the automatic setting units 60, 61 as input variables 57.

The automatic setting units 60, 61 may include characteristic diagrams, which may be saved in the memory 37 of the driver assistance system 36. In this regard, the computing device 38 may be configured to operate the given automatic setting unit 60, 61 as a characteristic diagram controller by accessing the saved characteristic diagrams. When optimizing the machine parameters of the threshing device 3 or the cleaning device 4, the given automatic setting unit 60, 61 may be configured to take into account the input variables 57, which are determined by the image evaluation, using the machine learning algorithm 43. Depending on the input variables 57, the given automatic setting unit 60, 61 may generate the control signals 58, 59 for automatically controlling at least one of the working units 62, through which a reduction or a minimization of the processing losses may be achieved.

In one or some embodiments, alternatively, or in addition, the image evaluation device 41 may be configured to display the results of the analysis to the operator of the combine harvester 1 via the operating and display unit 39.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | |
|---|---|
| 1 | Combine harvester |
| 2 | Front attachment |
| 3 | Threshing device |
| 4 | Cleaning device |
| 5 | Grain tank |
| 6 | Driver's cab |
| 7 | Distribution device |
| 8 | Harvested material |
| 9 | Inclined conveyor unit |
| 10 | Threshing drum |
| 11 | Threshing concave |
| 12 | Grain pan |
| 13 | Cleaning fan |
| 14 | Top sieve |
| 15 | Bottom sieve |
| 16 | Feed drum |
| 17 | Separating device |
| 18 | Ground |
| 19 | Separator concave |
| 20 | Cross-feeding screw conveyor |
| 21 | Returns pan |
| 22 | Screw conveyor |
| 23 | Grain elevator |
| 24 | Rear end of 1 |
| 25 | Transfer device |
| 26 | Chaff cutter |
| 27 | Trough |
| 28 | Conveying device |
| 29 | Harvested material flow |
| 30 | Harvested material flow |
| 31 | Harvested material flow |
| 32 | Partial flow |
| 33 | Residual harvested material flow |
| 34 | Transferred material flow |
| 35 | Harvested material flow |
| 36 | Driver assistance system |
| 37 | Memory |
| 38 | Computer device |
| 39 | Operating and display unit |
| 40 | Guide surface |
| 41 | Image evaluation device |
| 42 | Camera |
| 43 | Machine learning algorithm |
| 44 | Wall segment |
| 45 | Viewing window |
| 46 | Delivery area |
| 47 | Transfer area |
| 48 | Computing unit |
| 48A | Housing |
| 48B | LED array |
| 49 | Component |
| 50 | Image |
| 51 | Whole grains |
| 52 | Broken grain |
| 53 | Husks |
| 54 | Non-grain component |
| 55 | Background |
| 56 | Classified image |
| 57 | Input variable |
| 57A | Threshing quality |
| 57B | Unthreshed fraction |
| 58 | Control signal |
| 59 | Control signal |
| 60 | Automatic setting unit |
| 61 | Automatic setting unit |
| 62 | Work unit |
| 63 | Communication interface |

1. A combine harvester comprising:
a plurality of working units comprising a threshing device, a separating device, and a cleaning device, wherein the threshing device and separating device configured to process harvested material collected by the combine harvester for separating grain and transfer a flow of harvested material containing the grain to the cleaning device, wherein the cleaning device is configured to: supply the flow of harvested material containing unthreshed harvested material to the threshing device for rethreshing using a transfer device; and supply a cleaned flow of harvested material to a grain tank using a conveyor device;
a camera system configured to record one or more images of the flow of material;
an image evaluation device configured to:
analyze the one or more images; and
determine, based on the analysis of the one or more images, one or more indicators of processing losses caused by one or more of the plurality of working units; and
a driver assistance system configured to control, based on the one or more indicators, at least one of the plurality of working units.

2. The combine harvester of claim 1, wherein the flow of material that is transferred for rethreshing comprises a flow of transferred harvested material;
wherein the camera system is configured to record the one or more images of the flow of transferred harvested material; and
wherein the image evaluation device is configured to analyze the one or more images of the flow of transferred harvested material.

3. The combine harvester of claim 2, wherein the one or more indicators comprise one or both of a threshing quality or a detected portion of unthreshed fractions of the harvested material in the flow of transferred harvested material.

4. The combine harvester of claim 3, wherein the one or more indicators comprise both of the threshing quality and the detected portion of unthreshed fractions of the harvested material in the flow of transferred harvested material.

5. The combine harvester of claim 3, wherein the unthreshed fractions comprise one or more of whole ears, filled ear tips, aristate grains, covered grains, panicles, or spindle segments covered with grains.

6. The combine harvester of claim 3, wherein the threshing quality is determined by one or more of a broken grain fraction, cracks in the grain, a portion of unthreshed fractions, a portion of non-grain components, or a portion of foreign matter in the flow of transferred material.

7. The combine harvester of claim 3, wherein the processing losses comprise a loss portion of the unthreshed fractions of the harvested material separated from the combine harvester by the separating device and the cleaning device, which has remained unprocessed due to the threshing quality achieved by settings of the threshing device.

8. The combine harvester of claim 1, wherein the camera system comprises at least one camera which is integrated into at least one component of the transfer device along a conveying path of the transfer device.

9. The combine harvester of claim 8, wherein the flow of material that is transferred for rethreshing comprises a flow of transferred harvested material;
wherein the transfer device comprises a guide surface below the cleaning device, a cross-feeding screw conveyor positioned in a trough, and a conveyor device;
wherein the flow of transferred harvested material, separated by the cleaning device, is configured to pass via the guide surface into the cross-feeding screw conveyor; and
wherein the cross-feeding screw conveyor is configured to feed the flow of transferred harvested material to the threshing device via the conveyor device.

10. The combine harvester of claim 9, wherein the at least one camera is integrated in one or both of:
the guide surface, in a trough, along a conveying path of the conveyor device, in a delivery area of the conveyor device above the threshing device; or
a transfer area between the cross-feeding screw conveyor and the conveyor device.

11. The combine harvester of claim 10, wherein a first camera is integrated in the guide surface, in the trough, along the conveying path of the conveyor device, in the delivery area of the conveyor device above the threshing device; and
wherein a second camera is integrated in the transfer area between the cross-feeding screw conveyor and the conveyor device.

12. The combine harvester of claim 1, wherein the flow of material that is transferred for rethreshing comprises a flow of transferred harvested material; and
wherein the image evaluation device is configured to analyze the one or more images of the flow of transferred harvested material using a machine learning algorithm in order to determine the one or more indicators.

13. The combine harvester of claim 12, wherein the machine learning algorithm comprises at least one trainable neural network configured to analyze the one or more images; and
wherein the at least one trainable neural network is configured to analyze the one or more images received from the camera system pixel-by-pixel by:
using semantic segmentation; and
subjecting pixels in the one or more images to classification.

14. The combine harvester of claim 13, wherein the classification is based on classes from one or more of whole ears, filled ear tips, aristate grains, covered grains, panicles, spindle segments covered with grains, weed seeds, husks, stalks, pods, spindles, straw, or foreign bodies.

15. The combine harvester of claim 13, wherein the driver assistance system is configured to generate one or more control signals configured to control the at least one of the plurality of working units depending on the classification in order to reduce the processing losses.

16. The combine harvester of claim 1, wherein the driver assistance system, the threshing device, and the cleaning device each respectively form independently operating automatic setting units configured to optimize control of the threshing device and the cleaning device to perform a given partial working process.

17. The combine harvester of claim 16, wherein the image evaluation device is configured to generate the one or more indicators of the processing losses as input variables to independently operating automatic setting unit for the driver assistance system.

18. A method for operating a combine harvester, the method comprising:
using the combine harvester, wherein the combine harvester includes a plurality of working units comprising a threshing device, a separating device, and a cleaning device, wherein the threshing device and separating device configured to process harvested material collected by the combine harvester for separating grain and transfer a flow of harvested material containing the grain to the cleaning device, wherein the cleaning device is configured to: supply the flow of harvested material containing unthreshed harvested material to the threshing device for rethreshing using a transfer device; and supply a cleaned flow of harvested material to a grain tank using a conveyor device;
recording, by a camera system positioned in the combine harvester, one or more images of the flow of harvested material;
accessing the one or more images by an image evaluation device;
analyzing, by the image evaluation device, the one or more images of the flow of harvested material in order to determine one or more indicators of processing losses caused one or more of the plurality of working units; and
automatically controlling, by a driver assistance system and based on the one or more indicators of the processing losses, at least one of the plurality of working units.

19. The method of claim 18, wherein the flow of material that is transferred for rethreshing comprises a flow of transferred harvested material;
wherein the camera system records the one or more images of the flow of transferred harvested material;
wherein the image evaluation device analyzes the one or more images of the flow of transferred harvested material to determine the one or more indicators; and
wherein the one or more indicators comprise both of a threshing quality and a detected portion of unthreshed fractions of the harvested material in the flow of transferred harvested material.

20. The method of claim 19, wherein the image evaluation device determines the processing losses by determining a loss portion of the unthreshed fractions of the harvested material separated from the combine harvester by the separating device and the cleaning device, which has remained unprocessed due to the threshing quality achieved by settings of the threshing device; and
wherein the driver assistance system changes one or more of the settings of the threshing device in order to reduce the loss portion.
